(19) United States
(12) Patent Application Publication
(10) Pub. No.: US 2013/0125491 A1
(43) Pub. Date: May 23, 2013

(54) WALL PANEL STRUCTURE FOR A REFRIGERATED TRAILER

(71) Applicants: Patrick M. Griffin, Lafayette, IN (US); Andrzej Wylezinski, Lafayette, IN (US); Scott A. Storz, Lafayette, IN (US)

(72) Inventors: Patrick M. Griffin, Lafayette, IN (US); Andrzej Wylezinski, Lafayette, IN (US); Scott A. Storz, Lafayette, IN (US)

(21) Appl. No.: 13/663,023

(22) Filed: Oct. 29, 2012

Related U.S. Application Data
(60) Provisional application No. 61/563,170, filed on Nov. 23, 2011.

(51) Int. Cl. E04B 2/02; B32B 37/12; E04C 1/40

(52) U.S. Cl. 52/309.9; 156/60

(57) ABSTRACT

A sidewall for a refrigerated trailer includes a plurality of wall panels configured to extend along a horizontal length of the trailer. Each wall panel includes an outer wall member, an inner wall member spaced-apart from the outer wall member, and a foam core coupled to and extending between the inner and outer wall members.

This application claims priority under 35 U.S.C. §119(e) to U.S. Provisional Patent Application Ser. No. 61/563,170 filed Nov. 23, 2011 entitled WALL PANEL STRUCTURE FOR A REFRIGERATED TRAILER, the entirety of which is hereby incorporated by reference herein.

### FIELD OF THE INVENTION

The present invention relates generally to a wall panel for a trailer, and more specifically to a wall panel system for a refrigerated trailer or storage container.

### BACKGROUND

A refrigerated trailer or other refrigerated storage container typically includes first and second sidewalls, a floor assembly coupled to the first and second sidewalls, a roof assembly also coupled to the first and second sidewalls, a front wall assembly coupled at a front end of the trailer to the first and second sidewalls and to the roof and floor assemblies, and a rear end wall assembly coupled at a rear end of the trailer to the first and second sidewalls and to the roof and floor assemblies. Each of the first and second sidewalls typically includes one or more wall panels coupled to each other. Each wall panel includes an outer wall panel, an inner wall panel, and an insulating material between the inner and outer wall panels.

### SUMMARY

The present invention may comprise one or more of the features recited in the attached claims, and/or one or more of the following features and combinations thereof.

According to one aspect of the present disclosure, a sidewall for a refrigerated trailer includes a plurality of wall panels configured to extend along a horizontal length of the trailer. Each wall panel includes an outer wall member, an inner wall member spaced-apart from the outer wall member, and a foam core coupled to and extending between the inner and outer wall members. The side wall further includes a recessed channel formed between the inner wall of a first one of the plurality of wall panels and the inner wall of a second one of the plurality of wall panels adjacent the first one of the plurality of wall panels. The recessed channel is configured to receive a horizontally-extending track therein.

In one illustrative embodiment, the horizontally-extending channel may define a first recessed portion and a second recessed portion located inwardly toward the outer wall member from the first recessed portion. Further illustratively, the first recessed portion may be configured to receive the track therein. Each inner wall member may include a main body portion, a top joint member, and a bottom joint member. Illustratively, each of the top and bottom joint members may include a first inward step configured to define a portion of the first recessed portion and a second inward step configured to define a portion of the second recessed portion.

Illustratively, the top and bottom joint members may define a number of joint configurations in order to locate and/or mechanically lock adjacent inner wall members and adjacent outer wall members to each other. Illustratively, the horizontally-extending channel may be formed by the cooperation of adjacent top and bottom joint members of adjacent inner wall members. Alternatively, the horizontally-extending channel may be provided below the top joint member of an inner wall member or anywhere along a vertical height of the inner wall member.

Further illustratively, the inner and outer wall members may include inwardly-extending ribs which may extend perpendicularly or at an angle away from the main body of the respective inner and outer wall members. Alternatively, the ribs may be T-shaped, L-shaped, and/or may include barbs or exposed fibers thereon.

According to another aspect of the present disclosure, the sidewall may include a plurality of vertically-extending wall panels and a plurality of vertically-extending channels.

According to another aspect of the present disclosure, a sidewall for a refrigerated trailer includes a plurality of wall panels configured to extend along a horizontal length of the trailer. Each wall panel includes (i) an outer wall member, (ii) an inner wall member spaced-apart from the outer wall member, and (iii) a foam core coupled to and extending between the inner and outer wall members. Each outer wall member includes a main body portion, a top joint member coupled to the main body portion, and a bottom joint member coupled to the main body portion. The top joint member of each outer wall member is configured to be received within the bottom joint member of an adjacent outer wall member in order to mechanically lock adjacent wall members with each other.

In one illustrative embodiment, a coupling motion between the top and bottom joint members of adjacent outer wall members may generally be perpendicular to the main body portion. Alternatively, the coupling motion between the top and bottom joint members of adjacent outer wall members may generally parallel to the main body portion.

In another illustrative embodiment, one of the top joint member and the bottom joint member may include (i) a flange parallel to and spaced-apart from the main body and (ii) a protrusion coupled to and extending away from the flange. Further, the other one of the top joint member and the bottom joint member may include a protrusion-receiving cavity configured to receive the protrusion therein. Illustratively, the protrusion may include two spaced-apart ribs defining a channel therebetween. Each rib may include a retainer lip. Illustratively, the protrusion-receiving cavity may be defined by a female component including feet which define a lip configured to engage the retainer lip of each of the ribs of an adjacent outer wall panel in order to maintain the protrusion within the protrusion-receiving cavity. Further illustratively, the sidewall may include adhesive within the channel defined by the ribs of the protrusion.

In another illustrative embodiment, the sidewall may also include a horizontally-extending recessed channel formed within (i) the inner wall of a first one of the plurality of wall panels and (ii) the inner wall of a second one of the plurality of wall panels adjacent the first one of the plurality of wall panels. Illustratively, the recessed channel may be configured to receive a horizontally-extending track therein. Further illustratively, the horizontally-extending channel may include a first recessed portion and a second recessed portion located inwardly toward the outer wall member from the first recessed portion. The first recessed portion may be configured to receive the track therein. Further illustratively, each inner wall member may include a main body portion, a top joint member, and a bottom joint member. Each of the top and bottom joint members may also include a first inward step configured to define a portion of the first recessed portion and a second inward step configured to define a portion of the second recessed portion.

In another illustrative embodiment, each of the inner wall members may include a horizontally-extending channel formed therein, wherein the horizontally-extending channel includes a first recessed portion and a second recessed portion located inwardly toward the outer wall member from the first recessed portion, and wherein the first recessed portion is configured to receive the track therein.

In yet another illustrative embodiment, each of the inner and outer wall members may include a plurality of ribs coupled to an inner surface of the respective main body of each of the inner and outer wall members. Illustratively, the plurality of ribs may each be configured to extend inwardly therefrom. Further illustratively, each rib may be angled relative to the main body. Alternatively, each rib may be generally L-shaped when viewed in cross-section. Further illustratively, the ribs of the inner wall member may be staggered from those ribs of the outer wall member.

According to another aspect of the present disclosure, a sidewall for a refrigerated trailer includes a plurality of wall panels configured to extend along a horizontal length of the trailer. Each wall panel includes (i) an outer wall member, (ii) an inner wall member spaced-apart from the outer wall member, and (iii) a foam core coupled to and extending between the inner and outer wall members. Each outer wall member includes a main body portion, a top joint member coupled to the main body portion, and a bottom joint member coupled to the main body portion. Further, the top joint member of each outer wall member is configured to be received within the bottom joint member of an adjacent outer wall member by a coupling motion between the top and bottom joint members of adjacent outer wall members that is generally perpendicular to the main body in order to mechanically lock adjacent outer wall members to each other. The sidewall further includes a plurality of ribs coupled to each of the inner and outer wall members. The plurality of ribs of each of the inner and outer wall members extend inwardly and are staggered from each other.

According to still another object of the present disclosure, a method of assembling adjacent, longitudinally-extending outer wall members of a refrigerated trailer includes laying first and second outer panels on a support surface, positioning a bottom joint member of the first outer panel adjacent a top joint member of the second outer panel, placing an adhesive within a portion of at least one of the bottom and top joint member, and advancing the adjacent bottom and top joint members under a roller in order to mechanically lock the top and bottom joint members to each other.

### BRIEF DESCRIPTION OF THE DRAWINGS

FIG. 1 is a perspective view of a trailer showing a plurality of horizontal wall panels of the trailer.

FIG. 2 is an exploded, perspective view of a portion of one of the horizontal wall panels of the trailer of FIG. 1 showing an outer wall member and an inner wall member of the wall panel.

FIG. 3 is a side view of a portion of adjacent outer wall members showing an adhesive bond between the two wall members.

FIG. 4 is a perspective view of a portion of an alternative outer wall member including inwardly-extending (i.e., toward a center of the wall panel) T-shaped ribs.

FIGS. 5-7 illustrate an alternative sidewall including a plurality of horizontally-extending wall panels which cooperate to define horizontally-extending recessed channels between two adjacent inner wall members which are configured to receive a horizontal track, or logistics strip, therein.

FIG. 5 is a perspective of a portion of an inner wall member of the wall panels of FIGS. 5-7 having upper and lower joint portions configured to mate with adjacent joint portions of another inner wall member in order to create the horizontal recessed channels therebetween.

FIG. 6 is a side view of a portion of adjacent inner wall members of the wall panel assembly of FIGS. 5-7.

FIG. 7 is a perspective view of a portion of the sidewall including three adjacent wall panels which cooperate to form two horizontal recessed channels, each configured to receive a logistics strips therein.

FIG. 8 is a side view of a portion of an alternative wall panel assembly showing two adjacent horizontally-extending outer wall members and an alternative joint formed therebetween.

FIG. 9 is a perspective view of the adjacent outer wall members of FIG. 8.

FIG. 10 is a side view of a portion of yet another alternative wall panel assembly showing two adjacent outer wall members and an alternative joint formed therebetween.

FIG. 11 is a side view similar to FIGS. 8 and 10 showing two adjacent outer wall members and yet another alternative joint formed therebetween.

FIG. 12 is a side view similar to FIGS. 8, 10, and 11 showing two adjacent outer wall members and still another alternative joint formed therebetween.

FIG. 13 is a perspective view of a portion of an alternative inner wall member.

FIG. 14 is an enlarged perspective view of a portion of the inner wall member of FIG. 13 showing a recessed portion at an upper end of the wall member.

FIG. 15 is a side view of a wall panel including the outer wall members shown in FIG. 12 and the inner wall members shown in FIG. 13.

FIG. 16a is a side view of a portion of an alternative outer wall member including ribs having exposed fibers extending outwardly therefrom.

FIG. 16b is a side view of a portion of an alternative outer wall member including ribs having barbs thereon.

FIG. 17 is a side view of a portion of an alternative outer wall member including an angled rib extending therefrom.

FIG. 18 is a side view of a portion of an alternative outer wall member including an L-shaped rib extending therefrom.

FIG. 19 is a side view of a portion of yet another alternative wall panel showing two adjacent outer wall members and an alterative joint formed therebetween.

FIG. 20 is a side view of a portion of still another alternative wall panel showing two adjacent outer wall members and an alterative joint formed therebetween.

FIG. 21 is a perspective view of an alternative sidewall including vertically-extending wall panels and showing adjacent outer wall members of the wall panels cooperating to form vertically-extending recessed channel configured to receive a track, or logistics strip, therein.

FIG. 22 is a side view of the portion of the wall panel assembly of FIG. 8 showing adjacent wall panels being coupled together during manufacture of the wall panel assembly.

FIG. 23 is a side view of the portion of the wall panel assembly of FIG. 10 showing adjacent wall panels being coupled together during manufacture of the wall panel assembly.

FIG. 24 is a side view of the portion of the wall panel assembly of FIG. 11 showing adjacent wall panels being coupled together during manufacture of the wall panel assembly.

### DESCRIPTION OF THE ILLUSTRATIVE EMBODIMENTS

For the purposes of promoting an understanding of the principles of the invention, reference will now be made to illustrative embodiments shown in the attached drawings and specific language will be used to describe the same. While the concepts of this disclosure are described in relation to a truck trailer, it will be understood that they are equally applicable to other mobile or stationary storage containers, as well as refrigerated and un-refrigerated trailers, storage containers, or truck bodies. Accordingly, those skilled in the art will appreciate that the present invention may be implemented in a number of different applications and embodiments and is not specifically limited in its application to the particular embodiments depicted herein.

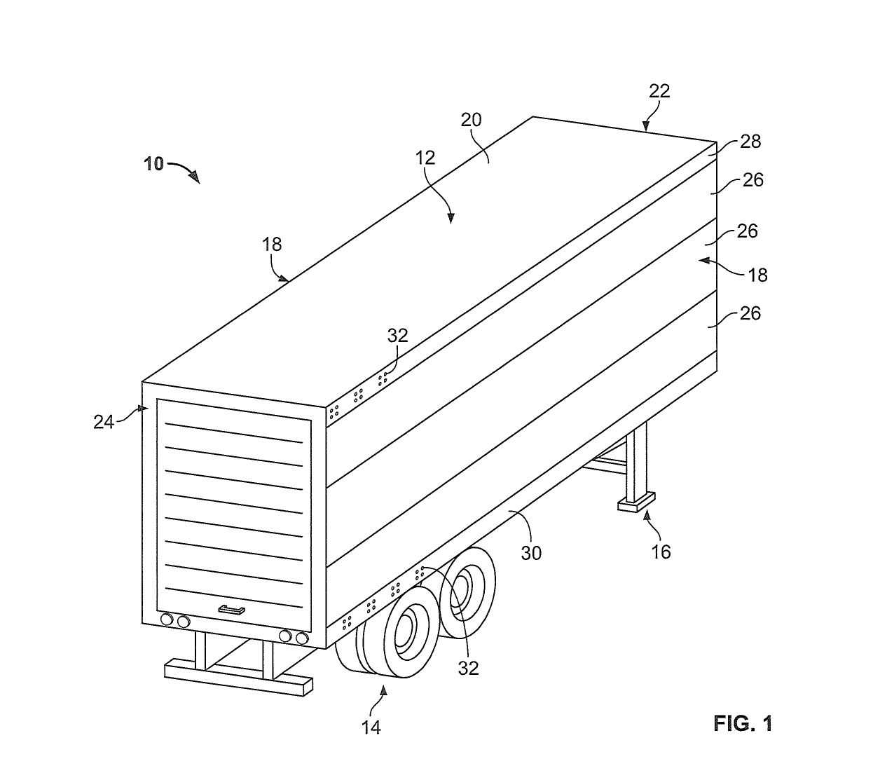

A trailer 10 of the present disclosure includes a storage container 12, a tandem axle assembly 14 coupled to a rear portion of the storage container 12, and landing gear 16 coupled to a front portion of the storage container 12, as shown in FIG. 1, in order to support the storage container 12 when the trailer 10 is not coupled to a tractor (not shown), for example. The storage container 12 further includes first and second sidewall assemblies 18, a roof assembly 20 coupled to each of the first and second sidewall assemblies 18, a front wall assembly 22 coupled to the sidewall assemblies 18 and the roof assembly 20, a rear end wall assembly 24 coupled to the sidewall assemblies 18 and the roof assembly 20, and a floor assembly (not shown) coupled to the sidewall assemblies 18 as well as the front and rear end wall assemblies 22, 24.

Illustratively, each sidewall assembly 18 includes a plurality of wall panels 26. As shown in FIG. 1, the wall panels 26 are configured to extend horizontally along the length of the storage container 12 such that a rear end of each wall panel 26 is coupled to the rear end wall assembly 24 and a front end of each wall panel 26 is coupled to the front wall assembly 22. Further, adjacent wall panels 26 are coupled to each other such that a bottom end of one wall panel 26 is coupled to and engaged with a top end of an adjacent wall panel 26. Illustratively, a top-most wall panel 26 is coupled to the roof assembly 20 while a bottom-most wall panel 26 is coupled to the floor assembly of the storage container 12. Illustratively, a top rail 28 is coupled to the top-most wall panel 26 while a base rail 30 is coupled to the bottom-most wall panel 26 of each sidewall assembly 18. Illustratively, the top and base rails 28, 30 may be coupled to the respective top and bottom-most wall panels 26 through the use of a fastener, such as a rivet 32, for example. It should be understood that other suitable fasteners may be used as well. Further, the top and base rails 28, 30 may also be coupled to the top and bottom-most wall panels 26 with the use of one or more adhesives in addition to or in lieu of the aforementioned fasteners. As illustrated in FIG. 1 each sidewall 18 includes three horizontally-extending wall panels 26. However, it is within the scope of this disclosure for each sidewall 18 to include any number of horizontally-extending wall panels 26. As is discussed in greater detail below, the trailer 10 may also include sidewalls made from one or more vertically-extending wall panels.

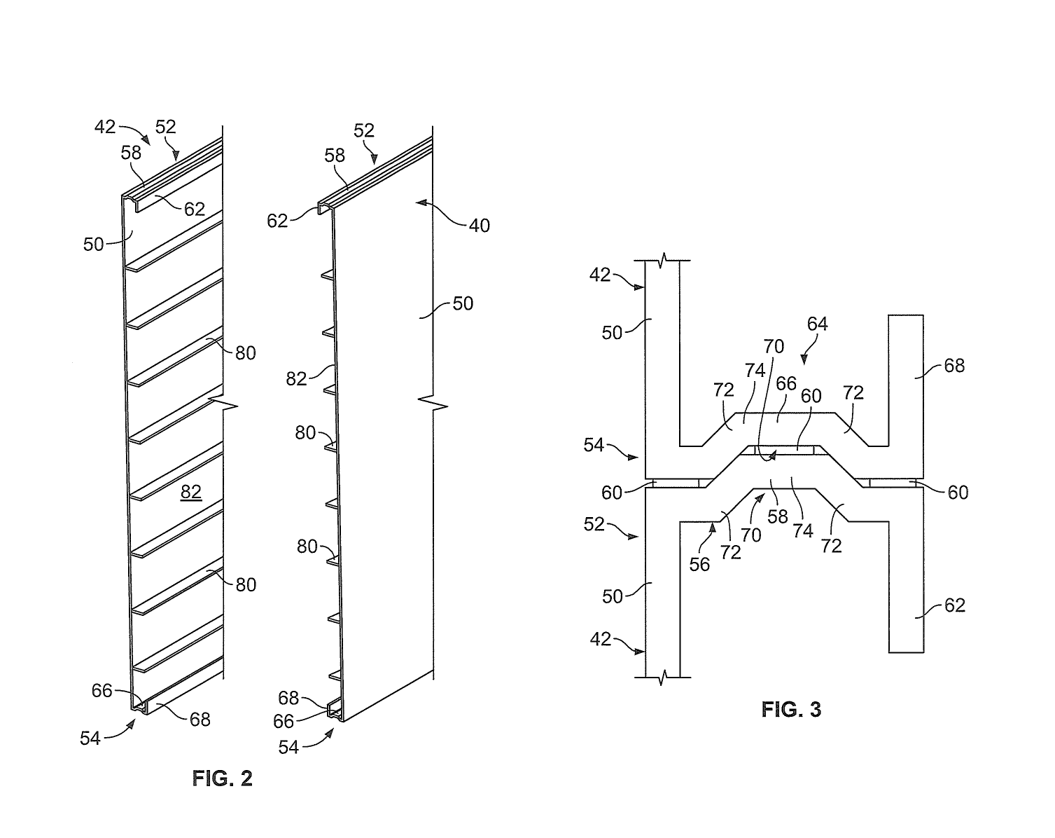

Each wall panel 26 includes an inner wall member 40, an outer wall member 42, and an insulating filler (not shown) between the inner and outer wall members 40, 42, as shown in FIG. 2. It should be understood that each wall member 40, 42 is configured to extend the entire length of the storage container 12 of the trailer 10. However, only a portion of the length of each wall member 40, 42 is shown in the figures herein. Illustratively, the inner and outer wall members 40, 42 are formed from a pultruded polymer. In particular, the inner and outer wall members 40, 42 are formed from a thermoset polymer. However, the inner and outer wall members 40, 42 may also be formed from a thermoplastic polymer, an extruded metal or metal alloy, roll-formed metal or metal alloy as well. Further, the inner and outer wall members 40, 42 may also be made from a fiber reinforced polymer pultrusion as well. It should also be understood that the inner and outer wall members 40, 42 may also be formed from metal or plastic that is not extruded or pultruded. Furthermore, the inner and outer wall members 40, 42 may be formed from other suitable materials as well. The insulation between the inner and outer wall members 40, 42 is illustratively a blown foam. However, other suitable materials having insulative properties may be used as well.

Each of the inner and outer wall members 40, 42 includes a main body 50, a top joint member 52 coupled to a top portion of the main body 50, and a bottom joint member 54 coupled to a bottom portion of the main body 50. The top and bottom joint members 52, 54 extend inwardly from the main body 50 such that the cross-section of each illustrative inner and outer wall member 40, 42 is generally C-shaped. As shown in FIG. 3, the top joint member 52 includes a horizontal arm 56 having an upwardly-extending bump or tongue 58. It should be understood, however, that the top joint member 52 may alternatively be configured to include an alternative horizontal arm having a downwardly-extending bump or tongue. The top joint member 52 further includes a vertical flange or lip 62 which extends downwardly from a distal end of the horizontal arm 56.

Similar to the top joint member 52, the bottom joint member 54 of the inner and outer wall members 40, 42 includes a horizontal arm 64 having an upwardly-extending bump or tongue 66 and a vertical flange or lip 68 which extends upwardly from a distal end of the horizontal arm 64. It should be understood that the bottom joint member 54 may alternative be configured to include an alternative horizontal arm having a downwardly-extending bump or tongue. As is discussed in greater detail below, the upwardly extending tongues 58, 66 of adjacent inner or outer wall members 40, 42 are configured to nest within each other, as shown in FIG. 3. Adhesive 60 is placed between the nesting tongues 58, 66 of adjacent inner or outer wall members 40, 42 in order to couple the adjacent inner or outer wall members 40, 42 together.

Illustratively, the upwardly-extending tongue 58, 66 of the wall members 40, 42, shown in FIGS. 2 and 3 also defines a corresponding channel 70. As shown in FIG. 3, each tongue 58, 66 and channel 70 run along the entire length of the respective top horizontal arm 56, 64 of the inner and outer wall members 40, 42. Illustratively, each tongue 58, 66 includes two angled side walls 72 and a horizontal wall 74 coupled to and positioned between the angled side walls 72. While the angled side walls 72 and horizontal wall 74 cooperate to define the tongue 58, it should be understood that the horizontal arms 56, 64 may include an upwardly-extending protrusion defining any suitable shape. The angled walls 72 operate to lock the inner and outer wall members 40, 42 via the tongues 58, 60. Additionally, the angled walls 72 define the required adhesive film thickness in the channels 60, 70.

As noted above, a plurality of outer wall members 42 are positioned adjacent to and on top of each other in order to couple the outer wall members 42 to each other such that the top joint member 52 of one wall member 42 is adjacent to and coupled with the bottom joint member 54 of another wall member 42, as shown in FIG. 3. Further, a plurality of inner wall members 40 are similarly positioned adjacent and on top of each other in order to couple the inner wall members 40 to each other such that the top joint member 52 of one wall member 40 is adjacent to and coupled with the bottom joint member 54 of another wall member 40. The inner wall members 40 are coupled to each other in the same or similar manner in which the outer wall members 42 are coupled to each other. Thus, only a description of adjacent outer wall members 42 is provided herein. As shown in FIG. 3, the tongue 58 of the top joint member 52 of one of the outer wall members 42 is received within the channel 70 of the bottom joint member 54 of the adjacent outer wall member 42. As such, the top joint member 52 nests within the adjacent bottom joint member 54 providing a tongue-and-groove connection or joint between the two adjacent outer wall members 42. This tongue-and-groove connection operates to locate two adjacent wall members 42 during assembly. Also, the groove connection provides shear resistance. Further, adhesive 60 is placed between the respective top and bottom joint members 52, 54 of the adjacent outer wall member 42, as shown schematically in FIG. 3, in order to permanently, or more rigidly couple the adjacent outer wall members 42 to each other.

Looking to FIG. 2, each of the outer and inner wall members 40, 42 further includes a plurality of ribs 80 coupled to the main body 50 of the respective wall member 40, 42 and configured to extend inwardly from an inner surface 82 of the main body 50 of the wall member 40, 42 and are generally perpendicular to the main body 50 of the wall members 40, 42. Illustratively, the ribs 80 of the inner wall member 40 are staggered from those of the corresponding, or facing, outer wall member 42 such that ribs 80 of the inner wall member 40 are not aligned with or in the same plane as any of the ribs 80 of the outer wall member 42. Staggering the ribs 80 operates to prevent heat transfer through the insulation from the inner wall member 40 to the outer wall member 42. It should be understood, however, that any suitable spacing between the ribs 80 on each of the inner wall member 40 and the outer wall member 42 may be used. Illustratively, the ribs 80 of the inner and outer wall members 40, 42 operate to provide additional surface area between the inner foam insulation and the inner and outer wall members 40, 42 in order to minimize and/or prevent the foam from becoming disengaged from either of the inner or outer wall members 40, 42 during assembly or use. In addition, the ribs 80 operate to increase the area of the “shear plane” provided through the volume of the insulation material. The insulation material has the lowest strength of all the materials in the sidewall construction. Therefore, it is beneficial to direct shear forces along larger surfaces to obtain higher resistance force.

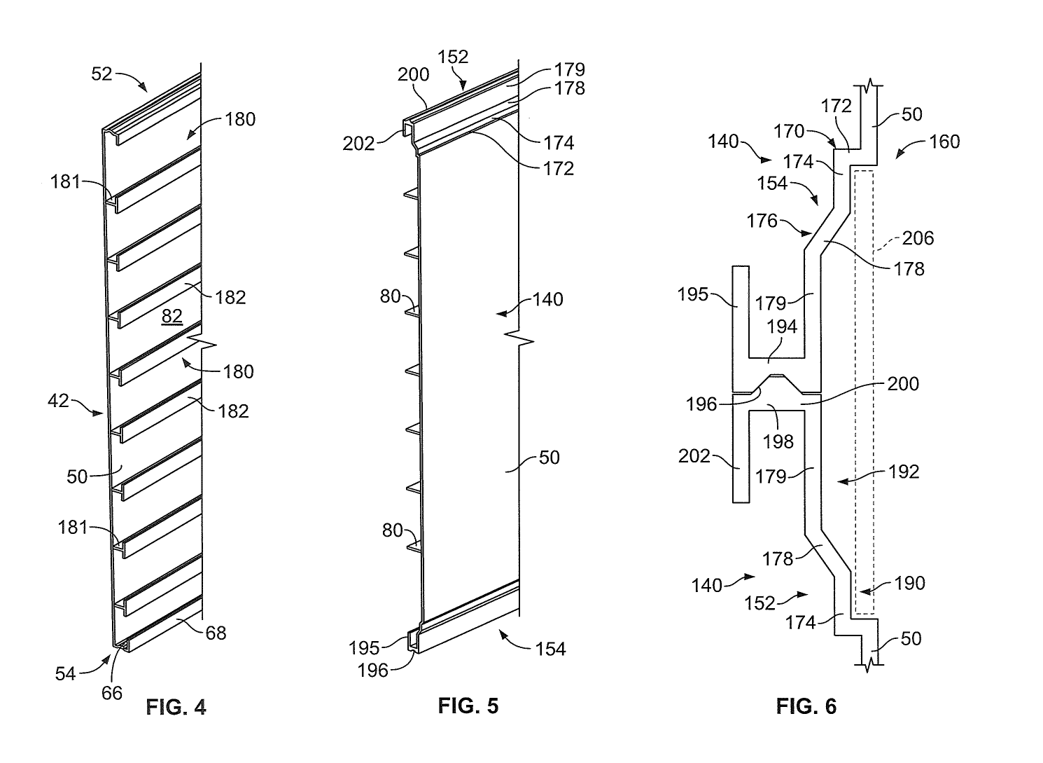

Further, while the inner and outer wall members 40, 42 include the ribs 80 shown in FIGS. 2, it is within the scope of this disclosure to include other ribs such as the rib members 180 shown in FIG. 4, for example. As shown in FIG. 4, the outer wall member 42 includes the generally T-shaped rib members 180 which extend outwardly from the inner surface 82 of the main body 50 of the wall member 42. Each rib member 180 includes a horizontal flange 181 coupled to and extending inwardly from the main body 50, and a vertical flange 182 coupled to a distal end of the horizontal flange 181.

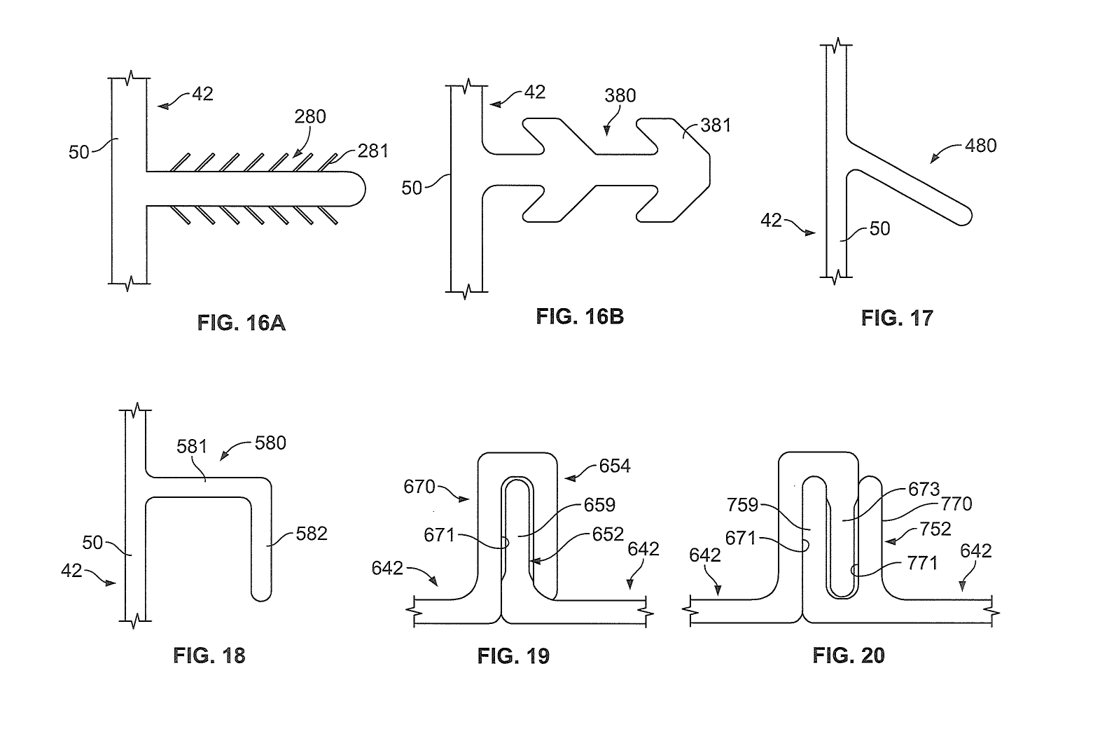

Looking now to FIGS. 16a-18, other alternative ribs are provided. As shown in FIG. 16a, for example, an outer member 42 includes an inwardly-extending rib 280 having exposed fibers 281 extending outwardly therefrom. It should be understood that the illustrative fibers 281 are merely illustrative and do not necessarily correspond to any particular actual length or width of any exposed fibers which may be extending outwardly therefrom. As shown in FIG. 16b, the outer member 42 includes an inwardly-extending rib 380 having barbs 381 extending therefrom. Illustratively, the barbs 381 may be angled in any suitable direction to any suitable degree and may have other shapes and sizes that that which is illustrated in FIG. 16b. As shown in FIG. 17, the outer member 42 includes an alternative rib 480 extending at a non-perpendicular angle away from the main body 50 of the outer member 42. Illustratively, the rib 480 is angled downwardly, but it should be understood that the rib 480 may alternatively be angled upwardly as well. Finally, as shown in FIG. 18, the outer member 42 includes a L-shaped rib 580 including a horizontal arm 581 extending generally perpendicularly from the main body 50 of the outer member 42, and a downwardly-extending arm 582 coupled to a distal end of the horizontal arm 581. It should be understood that the arm 582 may alternatively extend upwardly from the distal end of the horizontal arm 581 as well. The various inner and outer wall members disclosed herein may include one or more of any of the various ribs 80, 180, 280, 380, 480, 580 disclosed herein. It should also be understood that it is within the scope of the disclosure for the inner and outer wall members disclosed herein to include any suitable ribs having any suitable shape and size wherein the rib or ribs extend away from the main body 50 of the respective inner or outer wall member in an inward direction toward a center of the wall panel. As noted above, the various ribs 80, 180, 280, 380, 480, 580 disclosed herein operate to increase the surface area between the wall member and the insulative foam between the wall members in order to increase the adherence of the foam to the inner and outer wall members. Furthermore, the ribs 80, 180, 280, 380, 480, 580 may also operate to create a larger “shear plane” to resist the loads exerted to the sidewall.

As shown in FIG. 1, each side wall 18 of the trailer 10 includes three horizontal wall panels 26 which each also include an inner wall member 40, an outer wall member 42 spaced-apart from the inner wall member 40, and foam insulation (not shown) between the inner and outer wall members 40, 42. As noted above, while three horizontal wall panels 26 are shown, it should be understood that the trailer 10 may include any number of horizontal wall panels. It should also be understood that while the particular tongue-in-groove design of the joint members 52, 54 is shown in FIGS. 2 and 3 and described above, any suitable mechanical interlocking design may be used as well in order to locate and interlock adjacent wall members 40 or 42 with each other.

Looking now to FIGS. 5-7, an alternative side wall 118 for the trailer 10 includes a plurality of horizontally-extending wall panels 126. Similar to the wall panels 26 described above, each wall panel 126 includes the outer wall member 42 and an alternative inner wall member 140 (as shown in FIGS. 5 and 6). Each wall panel 126 further includes insulative foam (not shown) between the inner and outer wall members 140, 42. Many components of the inner wall members 140 are the same as or similar to the components of the inner wall members 40 described above; as such, like reference numbers are used to described the same or similar such components.

Looking to FIGS. 5-7, the inner wall members 140 each include a top joint member 152 and a bottom joint member 154. The top and bottom joint members 152, 154 of adjacent inner wall members 140 operate to locate and interlock the adjacent inner wall members 140 to each other. As is discussed in greater detail below, the interlocking top and bottom joint members 152, 154 operate to create a recessed area 160 configured to receive a horizontally-extending track (such as the track 206 shown in phantom in FIG. 6) such as a logistics strip therein. In particular, the top and bottom joint members 152, 154 each include a first L-shaped step 170 having a horizontal member 172 and a vertical member 174, a second generally L-shaped step 176 having a first member 178 and a second, vertical member 179. Illustratively, member 178 is angled inwardly, as shown in FIG. 6, but may also be positioned to lie horizontally similar to member 172. As is discussed below, the first step 170 and the second step 176 cooperate with adjacent first and second steps 170, 176 of the bottom joint member 154 of an adjacent inner wall member 140 to create a first recessed area 190 generally defined by the first steps 170 and a second recessed area 192 inward of the first recessed area and generally defined by the second steps 176. The bottom joint member 154 further includes a horizontal arm 194 having an upwardly-facing groove 196 formed therein and a vertical arm 195 coupled to a distal end of the horizontal arm 194 and extending upwardly therefrom.

Similar to the bottom joint member 154, the top joint member 152 includes a horizontal arm 198 having an upwardly-facing tongue or bump 200 formed therein. The horizontal arm 198 extends inwardly away from the vertical member 179 of the second step 176. The top joint member 152 further includes a vertical arm 202 coupled to a distal end of the horizontal arm 198 and extending downwardly therefrom, as shown in FIG. 6.

In use, the upwardly-facing tongue 200 of the top joint member 152 is received within the groove 196 of the bottom joint member 154 in order to locate two adjacent inner wall members 140 with each other. Additionally, the tongue-and-groove design provides shear resistance between two adjacent wall members. The recess 160 is formed at the joint of two adjacent inner wall members 140 and, as mentioned above, includes a first recess portion 190 and a second recess portion 192. As shown in phantom in FIG. 6, a track 206 is received within the recess 160 to be positioned in the first recess portion 190 such that a top portion of the track 206 rests against the vertical member 174 of each of the top and bottom joint members 152, 154 of adjacent inner wall members 140. When the track 206 is received within the first recess portion 190, the top and bottom joint members 152, 154 cooperate to define the second recess portion 192 behind (or inwardly) of the track 206. In use, cargo is oftentimes held in place within the interior of the storage container 12 by a plurality of straps. Such straps may include hooks or other end fasteners which may be received within apertures (not shown) defined within the tracks 206 in order to contain and secure the cargo within the storage container 12. The second recess 192 provides a space to receive a portion of the hook received through any one of the apertures in the track 206 without interfering with the other portions of the top and bottom joint members 152, 154 of each inner wall member 140. In other words, the first recess portion 190 defines a track-receiving recess configured to receive a horizontally-extending track 206, such as a logistics strip, therein, while the second recess portion 162 defines a hook-, or fastener-, receiving recess configured to receive a portion of a hook from a cargo strap or a load beam therein.

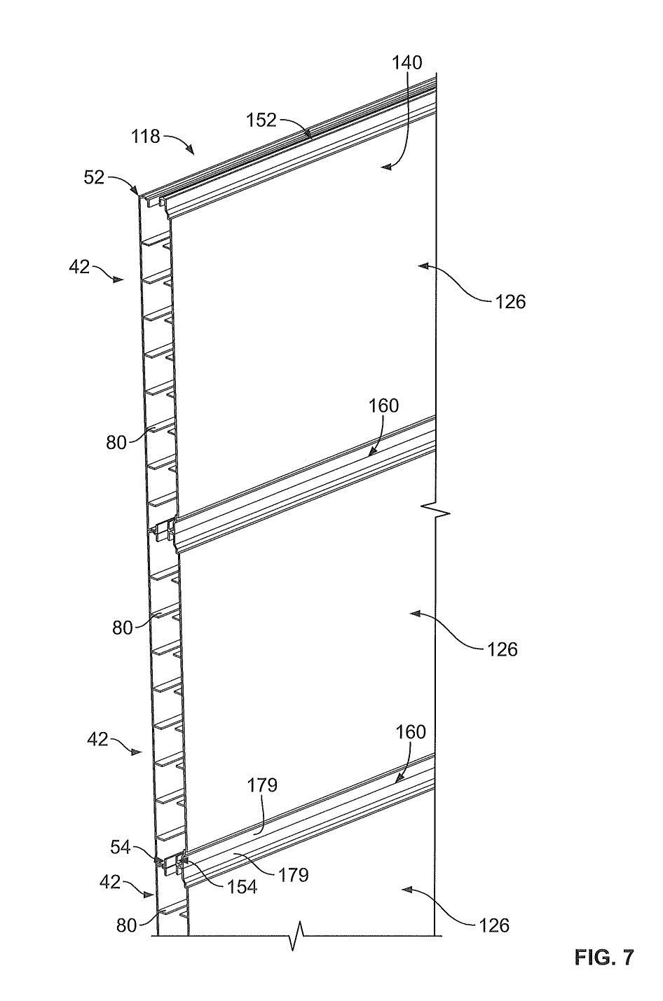

As shown in FIG. 7, the side wall 118 includes three wall panels 126 to provide two horizontally-extending recesses 160 of the side wall 118. It should be understood, however, that the side wall 118 may include any number of wall panels 126 to define any suitable number of horizontally-extending recesses 160 configured to receive tracks 206 therein.

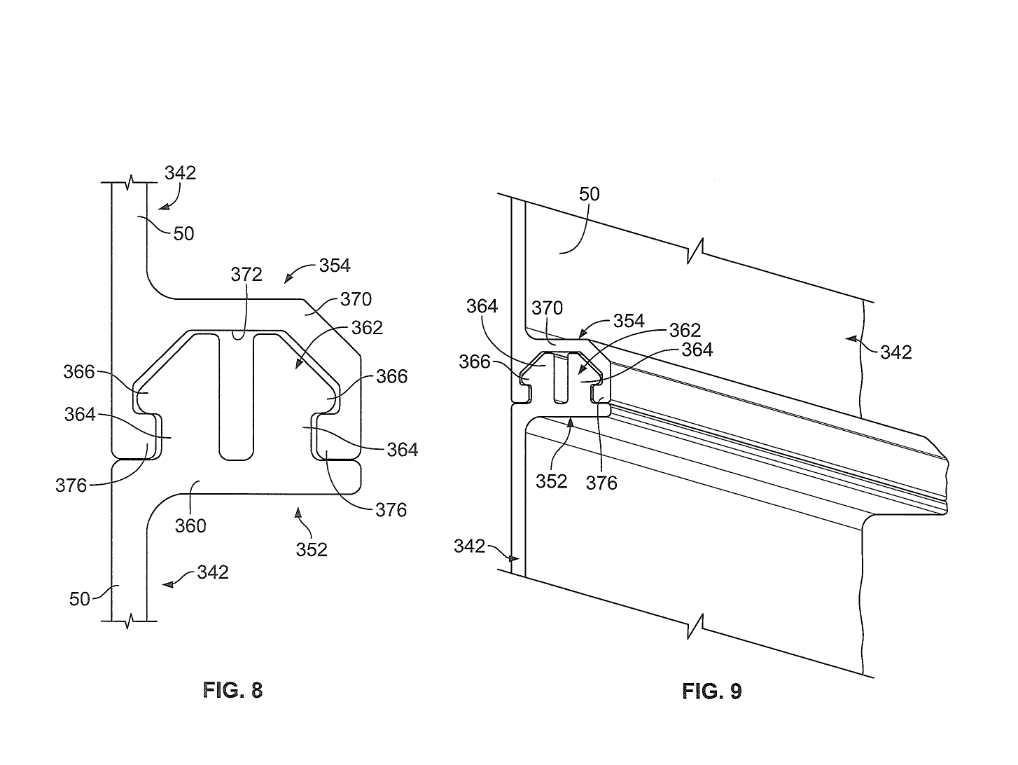

Looking now to FIGS. 8 and 9, an alternative outer member 342 is provided which includes an alternative top joint member 352 and an alterative bottom joint member 354 configured to be snapped into the top joint member 352 of an adjacent outer member 342 in order to provide a mechanical lock between the adjacent outer members 342. Illustratively, the top joint member 352 includes a flange 360 and a male component 362 coupled to the flange 360. The male component 362 includes two spaced-apart ribs 364 each having a retainer lip 366. Illustratively, the flange 360 extends inwardly from the main body 50 while the ribs 364 extend upwardly from a top surface of the flange 360. The bottom joint member 354 includes an inwardly extending flange, or female component, 370 defining a rib-receiving cavity 372 therein. Illustratively, the female component 370 includes first and second feet 376 which extend inwardly toward each other such that an opening into the rib-receiving cavity 372 is generally smaller than at least one internal diameter or dimension of the cavity 372. Accordingly, the feet 376 each define a lip or ledge configured to catch the retainer lip 366 therein when the ribs 364 of the top joint member 352 are received within the cavity 372 of the bottom joint member 354, as shown in FIGS. 8 and 9. Illustratively, the ribs 364 are movable toward each other such that the ribs 364 may be “snapped” into the cavity 372 of the female component 370. The top and bottom joint members 352, 354 of the outer wall members 342 cooperate to create a mechanical lock between the two adjacent wall members 342. In addition to the mechanical lock between the adjacent wall members 342, an adhesive may also be placed within the cavity 372 and/or on the ribs 364 of the respective joint members 352, 354 in order to further couple the adjacent wall members 342 to each other and provide a seal in order to protect the insulation material from moisture intrusion.

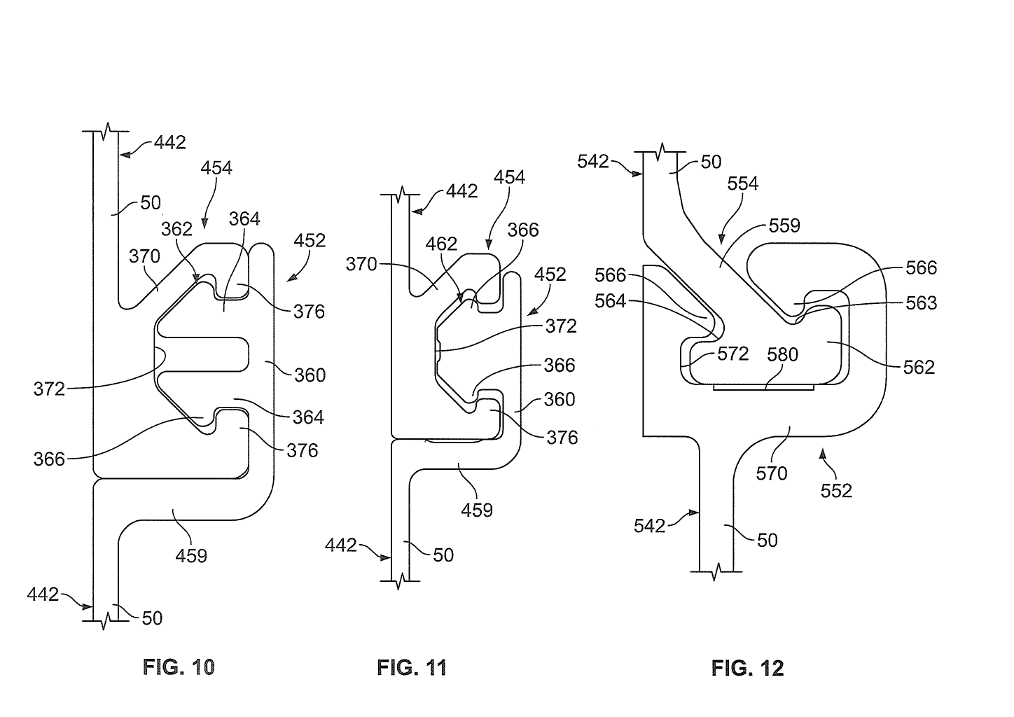

Looking now to FIG. 10, another alternative outer wall member 442 is provided. The outer wall member 442 includes an alternative top joint member 452 and an alternative bottom joint member 454. The top joint member 452 is configured to be snapped into the bottom joint member 454 of an adjacent outer wall member 442 in order to provide a mechanical lock between the adjacent outer wall members 442. Illustratively, the top and bottom joint members 452, 454 of the alternative outer wall members 442 of FIG. 10 are similar to the top and bottom joint members 352, 354 of the outer members 342 shown in FIGS. 8 and 9. As shown in FIG. 10, however, the top and bottom joint members 452, 454 are generally rotated 90 degrees counterclockwise from the top and bottom joint members 352, 354 of FIGS. 8 and 9. As such, the top joint member 452 includes a flange 459 which extends inwardly from the main body 50 and is generally perpendicular to the main body 50. The second flange 360 of the top joint member 452 extends upwardly from the flange 459 such that the second flange 360 is generally parallel to the main body 50. The male component 362 is coupled to the flange 360 and includes the two spaced-apart ribs 364 each having a retainer lip 366 as discussed above in regard to the top joint member 352 of FIGS. 8 and 9. Illustratively, the male component 362 extends outwardly from the second flange 360 in a direction toward the main body 50. The bottom joint member 454 includes the female component 370 defining the rib-receiving cavity 372 therein. Illustratively, the female component 370 of the bottom joint member 454 of the outer wall member 442 is oriented such that the rib-receiving cavity 372 is open inwardly whereas the rib-receiving cavity 372 of the female component 370 of the bottom joint member 354 of FIGS. 8 and 9 is oriented to open downwardly.

Similar to that described above, the feet 376 of the female component 370 catch the retainer lip 366 therein when the ribs 364 of the top joint member 452 are received within the cavity 372 of the bottom joint member 454, as shown in FIG. 10. Illustratively, the ribs 364 are movable toward each other such that the ribs 364 may be “snapped” into the cavity 372 of the female component 370. The top and bottom joint members 452, 454 of the outer wall members 442 cooperate to create a mechanical lock between the two adjacent wall members 442. In addition to the mechanical lock between the adjacent wall members 442, an adhesive may also be placed within the cavity 372 and/or on the ribs 364 of the respective joint members 452, 454 in order to further couple the adjacent wall members 442 to each other. Looking now to FIG. 11, an alternative male component 462 includes the two retainer lips 366, but does not include the spaced-apart ribs 364 of the component 362 shown in FIG. 10. Rather, a single component extending outwardly from the flange 360 is provided.

Looking now to FIG. 12, another alternative exterior wall member 542 is provided. The exterior wall member 542 includes an alternative top joint member 552 and an alternative bottom joint member 554 configured to be snapped into the top joint member 552 of an adjacent outer wall member 542 in order to provide a mechanical lock between the adjacent outer wall members 542. Illustratively, the bottom joint member 554 includes a flange 559 which extends outwardly at an angle from the main body 50. A male component 562 is coupled to the distal end of the flange 559 and includes a first notch 563 and a second notch 564 each configured to receive a portion of the top joint member 552 therein, as is discussed in greater detail below. The top joint member 552 includes a female component 570 including a cavity 572 configured to receive the male component 562 therein. Illustratively, the female component 570 includes first and second ribs, or detents, 566 configured to be received within the respective first and second notches 563, 564 of the male component 562 of the adjacent outer wall member 542. Illustratively, the male component 562 may be snapped into the cavity 572 of the female component 570. The top and bottom joint members 552, 554 of the outer wall members 542 cooperate to create a mechanical lock between the two adjacent wall members 542. In addition to the mechanical lock between the adjacent wall members 542, an adhesive may also be placed within the cavity 572 and/or on the outer surface of the male component 562 of the respective joint members 552, 554 in order to further couple the adjacent wall outer members 542 to each other. Illustratively, an adhesive-receiving cavity 580 is formed in the female component 570.

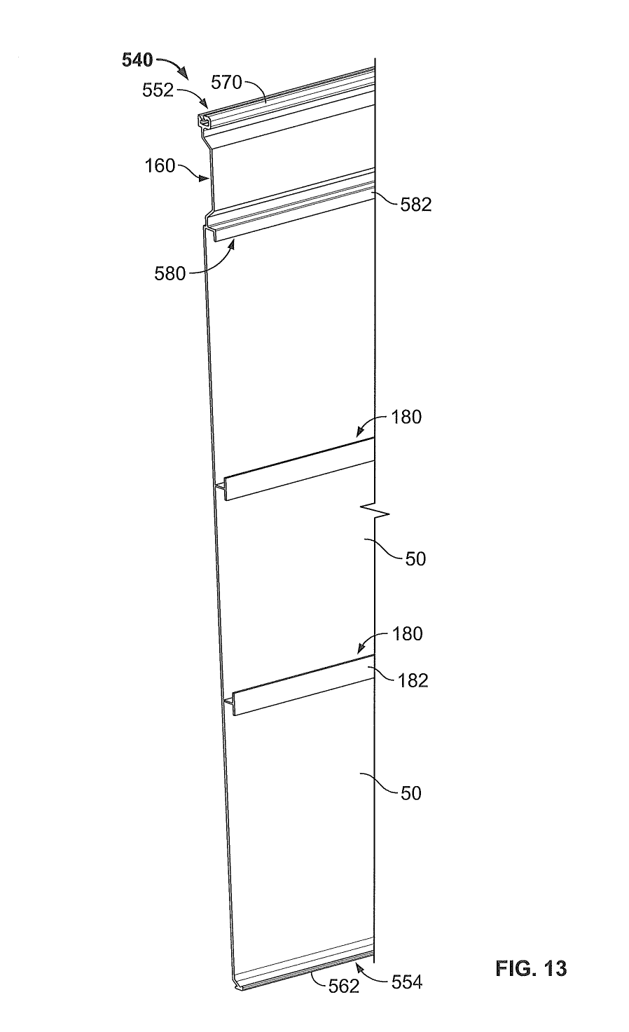

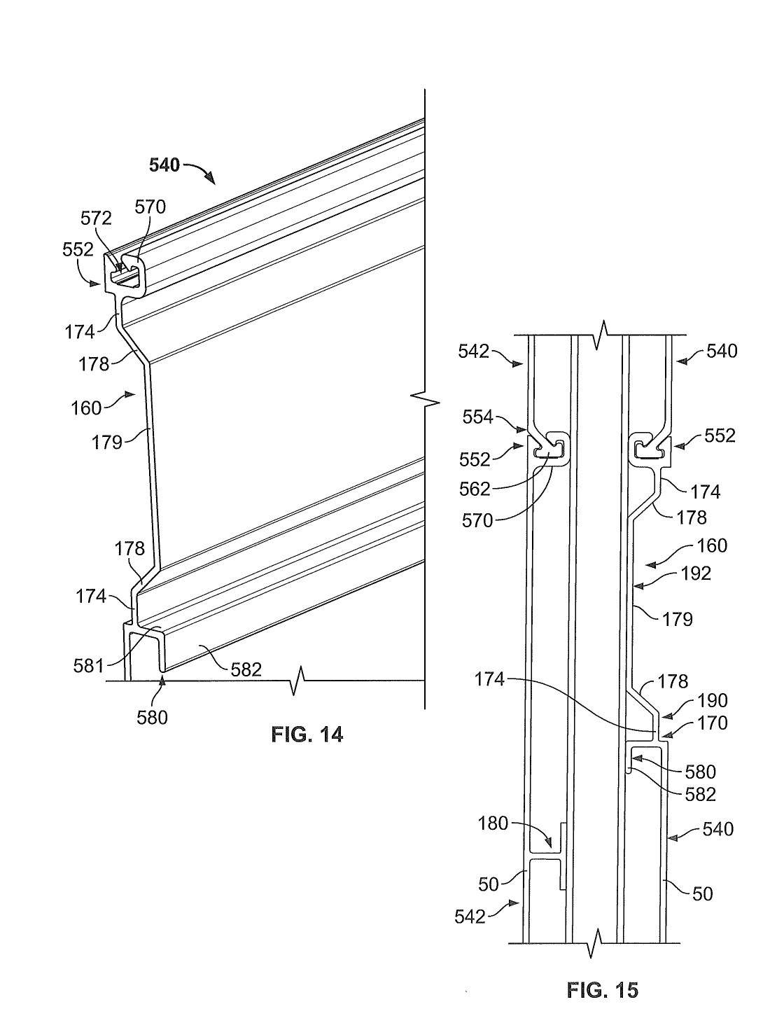

Looking now to FIGS. 13-15, a sidewall having an inner wall member 542 and an outer wall member 540 is provided. Illustratively, the recessed track 160 is formed at a top end of the main body portion 50 adjacent the top joint member 552. Accordingly, the recessed track 160 is formed entirely within the main body 50 of one of the outer wall members 540, rather than at the joint of adjoining outer wall members. However, adjacent wall members 540 may also cooperate to define the horizontal, recessed track 160 discussed above in regard to the inner wall members 140 and shown in FIGS. 6 and 7. Illustratively, the top and bottom joint members 552, 554 of the inner wall member 540 are the same as those of the outer wall member 542 shown in FIG. 12. As such, the same reference numbers are used to correspond to the same or similar components. Illustratively, the recessed track 160 is located below the top joint member 552 of the inner wall panel 540. As shown in FIGS. 14 and 15, the inner wall member 540 further includes an inwardly-extending L-shaped rib 580 configured to extend inwardly from the main body 50 of the wall panel 540. The inner wall member 540 further includes two other T-shaped ribs 180, as shown in FIG. 13. It should be understood that any of the inner wall panels disclosed herein may be configured to form the recessed track 160 when such adjacent inner wall panels are coupled to each other. Illustratively, the inner and outer wall members 542, 540 shown in FIG. 15 are bonded to an I-beam 545 located between the wall members 540, 542. However, it should be understood that the wall members 540, 542 may be bonded, or otherwise coupled, to any suitable vertical or horizontal member which operates to increase the overall stiffness of the sidewall assembly.

Looking now to FIG. 19, another alternative outer wall member 642 is provided. The outer wall member 642 includes an alternative top joint member 652 and an alterative bottom joint member 654 configured to be slid over the top joint member 652 in order to provide a mechanical lock between the adjacent outer wall members 642. Illustratively, the top joint member 652 includes a single flange 659 extending inwardly (in a direction toward a center of the wall panel) and the bottom joint member 642 includes a U-shaped component 670 which defines a channel 671 configured to receive the flange 659 of the adjacent outer wall member 642 therein. Illustratively, adhesive may be placed within the channel 671 and/or on the outer surface of the flange 659 in order to permanently couple the adjacent outer wall members 642 to each other after the adhesive cures.

Looking now to FIG. 20, the outer wall member 642 includes the bottom joint member 670 shown in FIG. 19 and discussed above, and further includes an alternative top joint member 752 having a U-shaped component 770 defining an inwardly-facing channel 771 therein. As shown in FIG. 20, an upper flange 759 of the U-shaped component 770 of the top joint member 752 is received within the outwardly-facing channel 671 of the U-shaped component 670 of the bottom joint member 654. Further a bottom flange 673 of the U-shaped component 670 of the bottom joint member 654 is received within the channel 771 of the top joint member 752. During manufacture the adjacent outer wall members 642 may be snapped together in order to provide a mechanical lock between the outer wall members 642. Further illustratively, adhesive may be placed within the channel 771 of the top joint member 752 and/or on the outer surface of the flange 673 of the bottom joint member 654 in order to permanently couple the adjacent outer wall members 642 to each other once the adhesive cures. Further, as shown in FIG. 20, adhesive placed within the channel 771 will be retained within the channel 771 during manufacture and assembly of a wall panel including adjacent outer wall members 642.

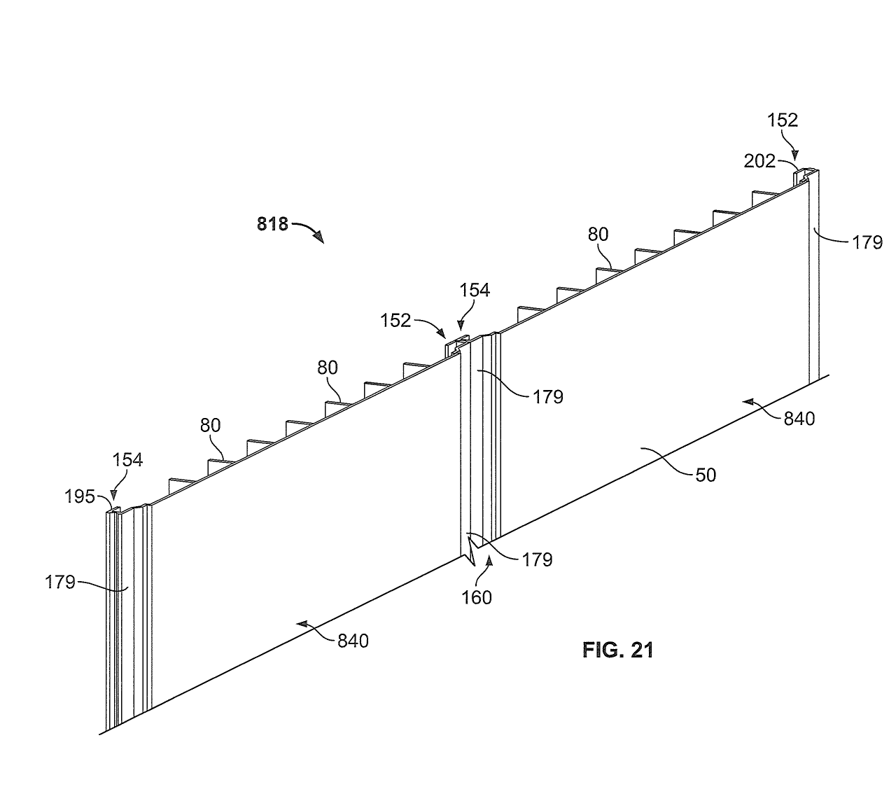

Looking now to FIG. 21, a portion of an alternative sidewall 818 includes a plurality of vertically-extending wall panels which each include a vertically-extending inner wall member 840, a vertically-extending outer wall member (not shown), and an insulation filling (not shown) between the inner and outer wall members 840. Illustratively, the vertically-extending inner wall members 840 include many of the same or similar features and components as the horizontally-extending inner wall members 140 shown in FIGS. 5-7. Accordingly, like reference numbers are used to denote the same or similar components. As shown in FIG. 21, for example, adjacent inner wall members 840 cooperate to define vertically-extending channels 160 configured to receive a vertically-extending track, or logistics strip, therein.

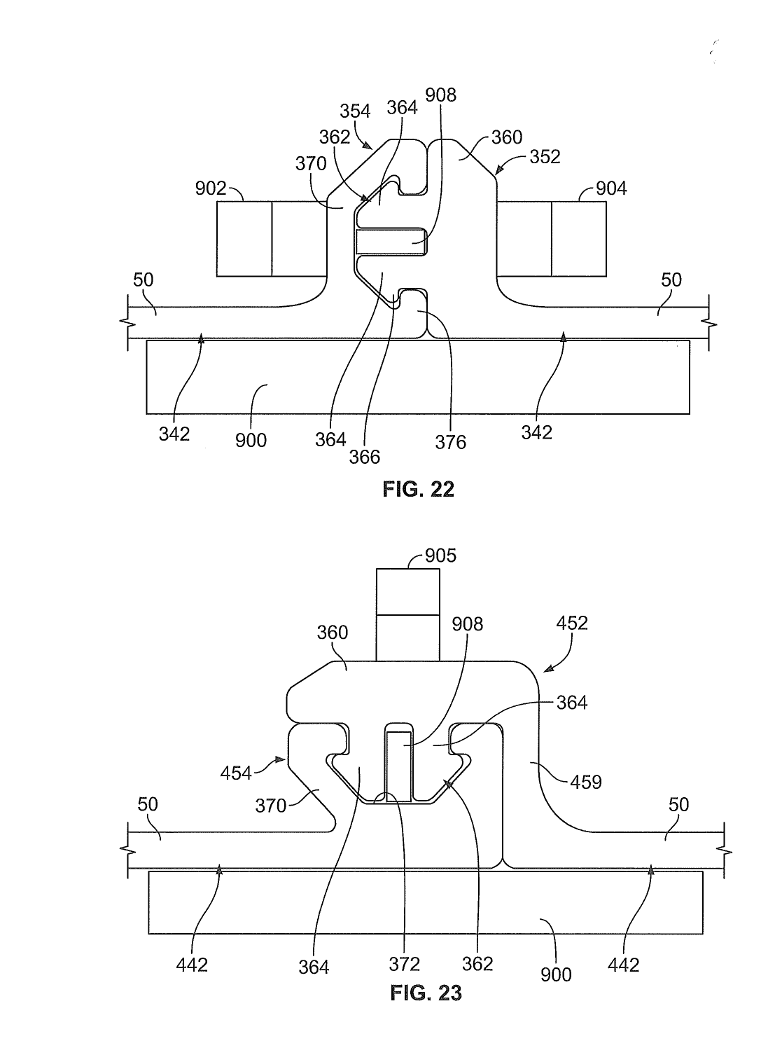

Looking now to FIG. 22, the two adjacent outer wall members 342 (shown and discussed previously with regard to FIG. 8) are shown during an assembly process for coupling the outer wall members 342 together. During the assembly process, the outer wall members 342 are arranged longitudinally side-by-side on a support table 900. Illustratively, this table 900 may be a moving table 900 such that the outer wall members 342 move with the table 900 relative to the inner and outer rollers 902, 904, as is discussed below. It should be understood, however, that the outer wall members 342 may remain stationary while the rollers 902, 904 move relative thereto. Once the adjacent wall members 342 are positioned on the support table 900, an adhesive 908 is dispensed into the channel between the spaced-apart ribs 364 of the male component 362 as the wall members 342 are advanced along the assembly line. Illustratively, the adhesive is a bonding or curing adhesive and may include a two-part epoxy, for example. It should be understood, however, that any suitable adhesive may be used.

Once the adhesive 908 is dispensed into the channel of the male component 362, the top joint member 352 and the bottom joint member 354 are fed between the rollers 902, 904 which operate to squeeze the joint members 352, 354 together such that the adjacent outer wall members 342 are “zipped” together as they are fed along the assembly line. In other words, the top joint member 352 of a first panel 342 is fed into the bottom joint member 354 of the adjacent second panel 342 and the rollers 902, 904 operate to snap or squeeze the two members 352, 354 into locking engagement with each other. Illustratively, a coupling motion between the top and bottom joint members 352, 354 is generally parallel to the main body 50 of the adjacent outer members 342. As the locking components (i.e., the top and bottom joint members 352, 354) are squeezed together by the rollers 902, 904, the adhesive 908 within the channel is squeezed out of the channel to adjacent internal interface surfaces of the top and bottom joint members 352, 354. Illustratively, the mechanical interface between the top and bottom joint members 352, 354 operates to hold the adjacent outer wall members 342 together during the time it takes for the adhesive 908 to cure and form a bonded joint between the adjacent wall members 342. Further, the use of the adhesive 908 operates to further prevent water ingression into the sidewall.

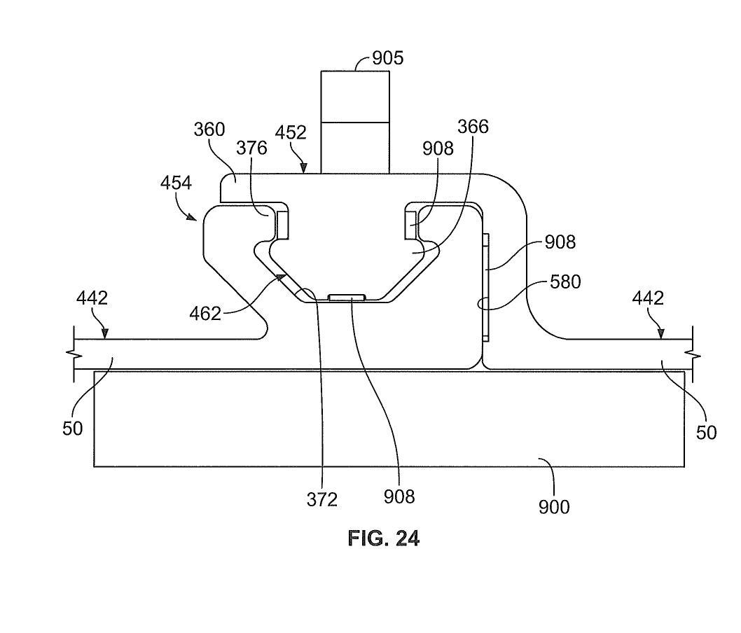

Looking now to FIGS. 23 and 24, the two adjacent outer wall members 442 (shown and discussed previously with regard to FIGS. 10 and 11) are shown during an assembly process for coupling the outer wall members 442 together. During the assembly process, and similar to the assembly process described above with regard to the outer wall members 342, the outer wall members 442 are arranged longitudinally side-by-side on the support table 900. As shown in FIG. 23, an adhesive 908 is dispensed into the channel between the spaced-apart ribs 364 of the male component 362 as the wall members 442 are advanced along the assembly line. With regard to the alternative male component 462, the adhesive 908 is dispensed into the smaller channel at the end of the male component 462 and within other side channels formed in the component 462, as shown in FIG. 24. It should be understood that adhesive 908 may also dispensed into the side channels of the male component of the outer wall members 342, 442 shown in FIGS. 22 and 23 as well. In fact, it should be understood that adhesive 908 may be dispensed or placed at any suitable location on the top and bottom joint members 352, 452, 354, 454 in order to bond the joint members to each other.

Next, the top and bottom joint members 452, 454 are fed under the roller 905 in order to squeeze the joint members 452, 454 together such that the adjacent outer wall members 442 are zipped together as they are fed along the assembly line. In other words, the top joint member 452 of a first panel 442 is fed into the bottom joint member 454 of the adjacent second panel 452 and the roller 905 operates to snap or squeeze the two members 452, 454 into locking engagement with each other. Illustratively, a coupling motion between the top and bottom joint members 352, 354 is generally perpendicular to the main body 50 of the adjacent outer members 342. As such, the support table 900 may be used to oppose the force of the single roller 905. As the locking components (i.e., the top and bottom joint members 452, 454) are squeezed together by the roller 905, the adhesive 908 within the channel is squeezed out of the channel to adjacent internal interface surfaces of the top and bottom joint members 452, 454. As discussed above in regard to the outer wall members 342, the mechanical interface between the top and bottom joint members 452, 454 operates to hold the adjacent outer wall members 42 together during the time it takes for the adhesive 908 to cure and form a bonded join between the adjacent wall members 442. Further, the use of the adhesive 908 operates to further prevent water ingression into the sidewall.

It should be understood that while various embodiments are disclosed herein that various features of each embodiment may be used with various features of other embodiments. For example, the interlocking joint members of the outer wall members shown in FIGS. 8-12, 19, and 20 may be used to join adjacent inner wall members together as well. Further, the recessed track 160 shown in FIGS. 5-7 is created by the cooperation of top and bottom joint members 152, 154 of adjacent inner wall members 140. In other words, the top joint member 152 of each inner wall member 140 includes recessed portions which cooperate with similar recessed portions of the bottom joint member 154 of an adjacent inner wall member 140 to define the longitudinally-extending recessed track 160. Such a recessed track 160 may be formed by the alternative inner wall members which include the interlocking joint members of the outer wall members shown in FIGS. 8-12, 19, and 20.

It should further be understood that top and bottom joint members of any particular inner or outer wall panel may be switched with each other. For example, the outer wall member 442 may alternatively include a top joint member similar to the bottom joint member 454 and may include a bottom joint member similar to the top joint member 452.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A sidewall for a refrigerated trailer, comprising:
a plurality of wall panels configured to extend along a horizontal length of the trailer, wherein each wall panel includes:
(i) an outer wall member,
(ii) an inner wall member spaced-apart from the outer wall member, and
(iii) a foam core coupled to and extending between the inner and outer wall members,
wherein each outer wall member includes a main body portion, a top joint member coupled to the main body portion, and a bottom joint member coupled to the main body portion, wherein the top joint member of each outer wall member is configured to be received within the bottom joint member of an adjacent outer wall member in order to mechanically lock adjacent wall members with each other.

2. The sidewall of claim 1, wherein a coupling motion between the top and bottom joint members of adjacent outer wall members is generally perpendicular to the main body portion.

3. The sidewall of claim 1, wherein a coupling motion between the top and bottom joint members of adjacent outer wall members is generally parallel to the main body portion.

4. The sidewall of claim 1, wherein one of the top joint member and the bottom joint member includes (i) a flange parallel to and spaced-apart from the main body and (ii) a protrusion coupled to and extending away from the flange, and wherein the other one of the top joint member and the bottom joint member includes a protrusion-receiving cavity configured to receive the protrusion therein.

5. The sidewall of claim 4, wherein the protrusion includes two spaced-apart ribs defining a channel therebetween, wherein each rib includes a retainer lip.

6. The sidewall of claim 5, wherein the protrusion-receiving cavity is defined by a female component including feet which define a lip configured to engage the retainer lip of each of the ribs of an adjacent outer wall panel in order to maintain the protrusion within the protrusion-receiving cavity.

7. The sidewall of claim 5, further comprising adhesive within the channel defined by the ribs of the protrusion.

8. The sidewall of claim 1, further comprising a horizontally-extending recessed channel formed within (i) the inner wall of a first one of the plurality of wall panels and (ii) the inner wall of a second one of the plurality of wall panels adjacent the first one of the plurality of wall panels, wherein the recessed channel is configured to receive a horizontally-extending track therein.

9. The sidewall of claim 8, wherein the horizontally-extending channel includes a first recessed portion and a second recessed portion located inwardly toward the outer wall member from the first recessed portion, and wherein first recessed portion is configured to receive the track therein.

10. The sidewall of claim 9, wherein each inner wall member includes a main body portion, a top joint member, and a bottom joint member, and wherein each of the top and bottom joint members includes a first inward step configured to define a portion of the first recessed portion and a second inward step configured to define a portion of the second recessed portion.

11. The sidewall of claim 1, wherein each of the inner wall members includes a horizontally-extending channel formed therein, wherein the horizontally-extending channel includes a first recessed portion and a second recessed portion located inwardly toward the outer wall member from the first recessed portion, and wherein the first recessed portion is configured to receive the track therein.

12. The sidewall of claim 1, wherein each of the inner and outer wall members includes a plurality of ribs coupled to an inner surface of the respective main body of each of the inner and outer wall members and configured to extend inwardly therefrom.

13. The sidewall of claim 12, wherein each rib is angled relative to the main body.

14. The sidewall of claim 12, wherein each rib is generally L-shaped when viewed in cross-section.

15. The sidewall of claim 12, wherein the ribs of the inner wall member are staggered from those ribs of the outer wall member.

16. A sidewall for a refrigerated trailer, comprising:
a plurality of wall panels configured to extend along a horizontal length of the trailer, wherein each wall panel includes:
(i) an outer wall member,
(ii) an inner wall member spaced-apart from the outer wall member, and
(iii) a foam core coupled to and extending between the inner and outer wall members,
wherein each outer wall member includes a main body portion, a top joint member coupled to the main body portion, and a bottom joint member coupled to the main body portion, wherein the top joint member of each outer wall member is configured to be received within the bottom joint member of an adjacent outer wall member by a coupling motion between the top and bottom joint members of adjacent outer wall members that is generally perpendicular to the main body in order to mechanically lock adjacent outer wall members to each other; and
a plurality of ribs coupled to each of the inner and outer wall members, wherein the plurality of ribs of each of the inner and outer wall members extend inwardly and are staggered from each other.

17. A method of assembling adjacent, longitudinally-extending outer wall members of a refrigerated trailer, comprising:
laying first and second outer panels on a support surface;
positioning a bottom joint member of the first outer panel adjacent a top joint member of the second outer panel;
placing an adhesive within a portion of at least one of the bottom and top joint member; and
advancing the adjacent bottom and top joint members under a roller in order to mechanically lock the top and bottom joint members to each other.
